(19) United States
(12) Patent Application Publication
(10) Pub. No.: US 2020/0340886 A1
(43) Pub. Date: Oct. 29, 2020

(54) FAILURE DETECTION DEVICE, MONITORING CONTROL SYSTEM, AND FAILURE DETECTION METHOD

(71) Applicant: Mitsubishi Electric Corporation, Chiyoda-ku, Tokyo (JP)

(72) Inventor: Shintaro YANAGIHARA, Tokyo (JP)

(73) Assignee: Mitsubishi Electric Corporation, Chiyoda-ku, Tokyo (JP)

(21) Appl. No.: 16/960,755

(22) PCT Filed: Jan. 15, 2018
(86) PCT No.: PCT/JP2018/000858

§ 371 Date: Jul. 8, 2020

(51) Int. Cl. G01M 99/00

(52) U.S. Cl. CPC G01M 99/00

(57) ABSTRACT

A failure detection device includes a state information acquisition unit, a failure determination unit, and a failure information output unit. The state information acquisition unit acquires, from a remote monitoring system that monitors a facility provided in a remote location, state information indicating a state of the remote monitoring system. The failure determination unit determines a failure in the remote monitoring system based on the state information acquired by the state information acquisition unit, and generates failure information indicating a detail of the failure determined. The failure information output unit outputs the failure information generated by the failure determination unit.

### FIELD

The present invention relates to a failure detection device, a monitoring control system, and a failure detection method.

### BACKGROUND

Conventionally, a monitoring control system that monitors and controls facilities such as a plant and a public accommodation have been known. Such a monitoring control system may not work normally due to causes such as long-term operation of the system and simultaneous operations performed by two or more users. When the monitoring control system does not work normally, a system administrator confirms states of devices constituting the monitoring control system and operation histories of the users to thereby check details of the system failure.

In Patent Literature 1, there is proposed a computer system that beforehand stores an operation history of a user when a system failure has occurred, and if the current operation is included in the operation history in which a failure has been caused, the computer system issues a warning so as not to lead to a system failure.

### CITATION LIST

### Patent Literature

Patent Literature 1: Japanese Patent Application Laid-open No. H10-105440

### SUMMARY

### Technical Problem

In the above-mentioned conventional system, a warning can be issued so as not to lead to a system failure on the basis of a user's operation, but it is necessary for the system administrator to confirm the operation states of devices constituting the system in the event of a system failure. Therefore, the burden on the system administrator is large, which is a problem.

The present invention has been made in view of the above circumstances, and an object thereof is to provide a failure detection device that can reduce the burden on the system administrator when a system failure occurs.

### Solution to Problem

In order to solve the above-described problem and achieve the object, the present invention provides a failure detection device comprising: a state information acquisition unit to acquire, from a remote monitoring system that monitors a facility provided in a remote location, state information indicating a state of the remote monitoring system; a failure determination unit to determine a failure in the remote monitoring system based on the state information acquired by the state information acquisition unit, and generate failure information indicating a detail of the failure determined; and a failure information output unit to output the failure information generated by the failure determination unit.

### Advantageous Effects of Invention

The present invention achieves an advantageous effect that the burden on the system administrator can be reduced when a system failure occurs.

### BRIEF DESCRIPTION OF DRAWINGS

FIG. 1 is a diagram illustrating an exemplary configuration of a monitoring control system according to a first embodiment.

FIG. 2 is a diagram illustrating a specific configuration example of a remote monitoring device according to the first embodiment.

FIG. 3 is a diagram illustrating an example of a monitoring information table stored in a monitoring information storage device according to the first embodiment.

FIG. 4 is a diagram illustrating a specific configuration example of a failure detection device according to the first embodiment.

FIG. 5 is a diagram illustrating an example of a first failure determination table stored in a failure determination information storage unit according to the first embodiment.

FIG. 6 is a diagram illustrating an example of an operation state information table stored in an operation state information storage unit according to the first embodiment.

FIG. 7 is a diagram illustrating an example of a second failure determination table stored in the failure determination information storage unit according to the first embodiment.

FIG. 8 is a diagram illustrating an example of a notification determination information table stored in a notification determination information storage unit according to the first embodiment.

FIG. 9 is a diagram illustrating an example of a failure information table stored in the failure determination information storage unit according to the first embodiment.

FIG. 10 is a flowchart illustrating an exemplary process that is performed by an information collecting device according to the first embodiment.

FIG. 11 is a flowchart illustrating an exemplary process that is performed by a monitoring processing device according to the first embodiment.

FIG. 12 is a flowchart illustrating an exemplary process that is performed by the failure detection device according to the first embodiment.

FIG. 13 is a flowchart illustrating an example of a process of step S32 illustrated in FIG. 12.

FIG. 14 is a flowchart illustrating an example of a process of step S34 illustrated in FIG. 12.

FIG. 15 is a flowchart illustrating an example of a process of step S36 illustrated in FIG. 12.

FIG. 16 is a flowchart illustrating an example of a process of step S38 illustrated in FIG. 12.

FIG. 17 is a flowchart illustrating an example of a process of step S41 illustrated in FIG. 12.

FIG. 18 is a diagram illustrating an exemplary hardware configuration of the failure detection device according to the first embodiment.

FIG. 19 is a diagram illustrating an exemplary configuration of a failure detection device according to a second embodiment.

FIG. 20 is a flowchart illustrating an exemplary process that is performed by the failure detection device according to the second embodiment.

### DESCRIPTION OF EMBODIMENTS

Hereinafter, a failure detection device, a monitoring control system, and a failure detection method according to embodiments of the present invention will be described in detail with reference to the drawings. The present invention is not necessarily limited to these embodiments.

### First Embodiment

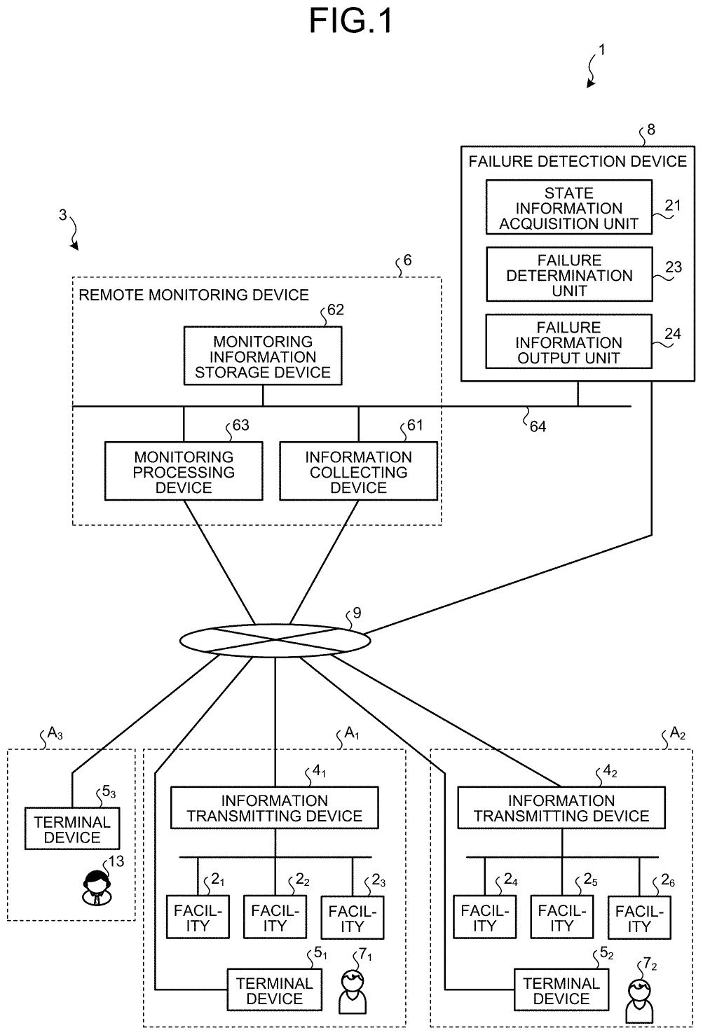

FIG. 1 is a diagram illustrating an exemplary configuration of a monitoring control system according to the first embodiment. The monitoring control system 1 illustrated in FIG. 1 monitors the states of facilities 2₁ to 2₆ and controls the facilities 2₁ to 2₆. The facilities 2₁ to 2₆ are facilities provided in a plant such as a water purification plant, an electric power plant, and a factory, or in a public accommodation, for example, and each include one or more devices. The facilities 2₁ to 2₃ are provided in a first area A₁, and the facilities 2₄ to 2₆ are provided in a second area A₂. Hereinafter, when the facilities 2₁ to 2₆ are not intended to be individually distinguished, they are referred to as the facility 2 or facilities 2.

The monitoring control system 1 includes a remote monitoring system 3 that monitors the facility 2 provided in a remote location, and a failure detection device 8 that detects a failure of the remote monitoring system 3. The monitoring control system 1 also includes a facility control device (not illustrated) that remotely controls the facility 2, and the facility 2 is remotely controlled by the facility control device.

The remote monitoring system 3 includes two or more information transmitting devices 4₁ and 4₂, terminal devices 5₁, 5₂, and 5₃, and a remote monitoring device 6. The remote monitoring device 6 is communicably connected to the two or more information transmitting devices 4₁ and 4₂ and the terminal devices 5₁, 5₂, and 5₃ via a communication network 9. The communication network 9 is, for example, a wide area network (WAN) such as the Internet.

Each facility 2 is equipped with a state measuring device of a type suitable for an object to be monitored. The state measuring device includes at least one of a meter and a sensor. The meter is, for example, a rain gauge, a water level gauge, a pressure gauge, or the like. The sensor is a temperature sensor, a voltage sensor, a current sensor, a flow sensor, a position sensor, or the like. A measurement target of the state measuring device includes the facility 2 and a target to be controlled by the facility 2. In the case of a power plant, the target to be controlled by the facility 2 is, for example, generated voltage and generated power.

The information transmitting device 4₁ is located in the first area A₁, and acquires measurement values from the state measuring devices (not illustrated) provided in the facilities 2₁ to 2₃. The information transmitting device 4₂ is located in the second area A₂, and acquires measurement values from the state measuring devices (not illustrated) provided in the facilities 2₄ to 2₆. Hereinafter, when the information transmitting devices 4₁ and 4₂ are not intended to be individually distinguished, they are referred to as the information transmitting device 4 or devices 4.

The information transmitting device 4 transmits monitoring information including a measurement value acquired from the state measuring device provided in each facility 2 and state information indicating the state of the information transmitting device 4 to the remote monitoring device 6 via the communication network 9. The state information is, for example, information indicating the operation state of the information transmitting device 4, and includes information indicating the operation state of each of hardware and software in the information transmitting device 4.

The terminal device 5₁ is used by a site worker 7₁ who manages the facility 2 in the first area A₁. The terminal device 5₂ is used by a site worker 7₂ who manages the facility 2 in the second area A₂. The terminal device 5₃ is used by a system administrator 13 who manages the monitoring control system 1 in an area A₃ remote from the first area A₁ and the second area A₂. Hereinafter, when the terminal devices 5₁, 5₂, and 5₃ are not intended to be individually distinguished, they are referred to as the terminal device 5 or devices 5, and when the site workers 7₁ and 7₂ are not intended to be individually distinguished, they are referred to as the site worker 7 or workers 7.

Each of the remote monitoring device 6, the failure detection device 8, and the above-described facility control device (not illustrated) is, for example, a virtual device constructed of one or more servers and one or more storages that constitute a cloud system built in a data center. Two or more devices such as servers and storages that constitute the cloud are communicably connected to each other by a communication network.

The remote monitoring device 6 includes an information collecting device 61, a monitoring information storage device 62, and a monitoring processing device 63. For example, the information collecting device 61, the monitoring processing device 63, and the failure detection device 8 are formed as virtual machines in different servers in a data center, and the monitoring information storage device 62 is formed as a virtual storage in one or more storages.

The information collecting device 61 receives monitoring information and state information from the plurality of information transmitting devices 4₁ and 4₂ via the communication network 9. The information collecting device 61 transmits the received monitoring information to the monitoring information storage device 62, and transmits the received state information and monitoring information to the failure detection device 8. The monitoring information storage device 62 stores the monitoring information transmitted from the information collecting device 61.

The monitoring processing device 63 acquires monitoring information from the monitoring information storage device 62, and generates monitoring screen information which is information indicating the state of the facility 2 based on the acquired monitoring information. The monitoring processing device 63 distributes the generated monitoring screen information to the terminal devices 5₁ and 5₂. The terminal devices 5₁ and 5₂ each acquire the monitoring screen information distributed from the monitoring processing device 63 via the communication network 9, and display, on a display unit (not illustrated), a monitoring screen that is based on the acquired monitoring screen information. The site worker 7 can grasp the state of the facility 2 by referring to the monitoring screens displayed on the terminal devices 5₁ and 5₂.

The failure detection device 8 includes a state information acquisition unit 21, a failure determination unit 23, and a failure information output unit 24. The failure detection device 8 detects a failure in the remote monitoring system 3, and outputs failure information including information indicating a detail of the detected failure. The state information acquisition unit 21 acquires, from the remote monitoring system 3, state information indicating the state of the remote monitoring system 3. For example, the state information acquisition unit 21 acquires, from the information collecting device 61, state information indicating the state of the information transmitting device 4.

The state information acquisition unit 21 also accesses the information collecting device 61, the monitoring information storage device 62, and the monitoring processing device 63 to acquire the operation log of each of the information collecting device 61, the monitoring information storage device 62, and the monitoring processing device 63. The state information acquisition unit 21 acquires, from the acquired operation log, state information indicating the state of each of the information collecting device 61, the monitoring information storage device 62, and the monitoring processing device 63. The state information is, for example, information such as the activation state, processing state, and communication state of the device.

The failure determination unit 23 determines a failure in the remote monitoring system 3 based on the state information acquired by the state information acquisition unit 21. For example, the failure determination unit 23 detects a failure in the information transmitting device 4 based on the state information indicating the state of the information transmitting device 4, and detects a failure in the remote monitoring device 6 based on the state information indicating the state of the remote monitoring device 6. The failure determination unit 23 generates failure information including information indicating a detail of the determined failure.

The failure information output unit 24 outputs the failure information generated by the failure determination unit 23 to the monitoring processing device 63. The monitoring processing device 63 generates failure notification screen information based on the failure information acquired from the failure detection device 8, and notifies the terminal device 5 of the generated failure notification screen information via the communication network 9. The failure notification screen information includes information indicating a detail of the failure in the remote monitoring system 3.

The control unit (not illustrated) of each of the terminal devices 5₁, 5₂, and 5₃ displays, on a display unit (not illustrated), the failure notification screen information provided from the failure detection device 8 via the remote monitoring system 3. The site workers 7₁ and 7₂ and the system administrator 13 can easily grasp a detail of the failure in the remote monitoring system 3 based on the failure notification screen information displayed on the terminal devices 5₁, 5₂, and 5₃.

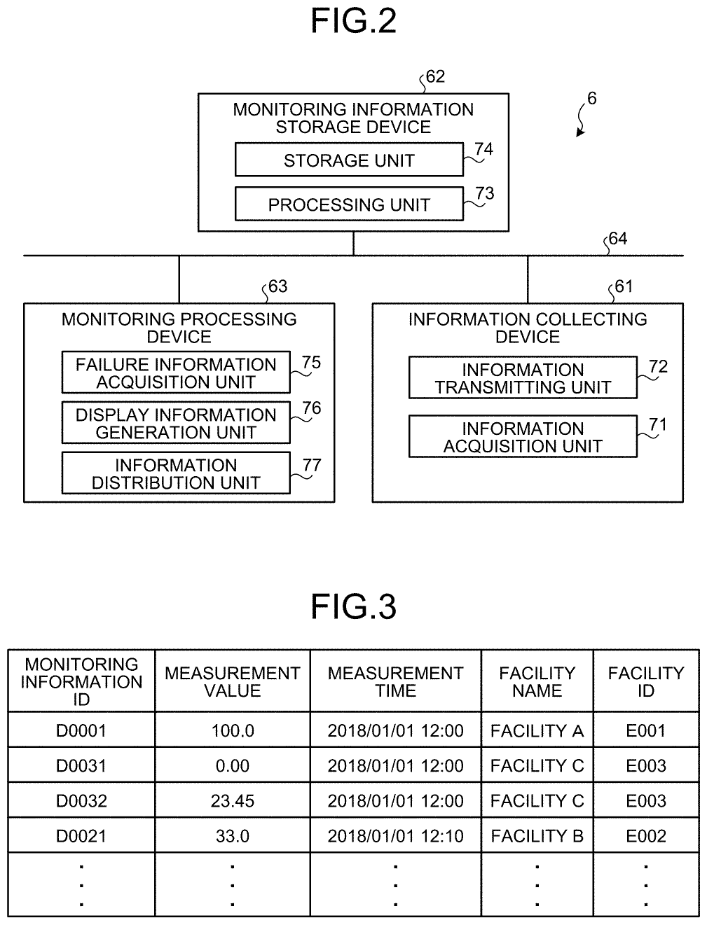

Hereinafter, the configurations of the remote monitoring device 6 and the failure detection device 8 according to the first embodiment will be described in more detail. FIG. 2 is a diagram illustrating a specific configuration example of the remote monitoring device according to the first embodiment.

The remote monitoring device 6 illustrated in FIG. 2 includes the information collecting device 61, the monitoring information storage device 62, and the monitoring processing device 63, as described above. The information collecting device 61, the monitoring information storage device 62, and the monitoring processing device 63 are communicably connected to one another via a communication network 64. The communication network 64 is, for example, a local area network (LAN), but may be a communication network other than the LAN or a communication bus.

The information collecting device 61 includes an information acquisition unit 71 and an information transmitting unit 72, as illustrated in FIG. 2. The information acquisition unit 71 receives monitoring information and state information from each information transmitting device 4 via the communication network 9. The information transmitting unit 72 transmits, to the monitoring information storage device 62 via the communication network 64, an information writing request including the monitoring information acquired by the information acquisition unit 71. The information transmitting unit 72 also transmits, to the failure detection device 8 via the communication network 64, the monitoring information and state information acquired by the information acquisition unit 71.

The monitoring information storage device 62 includes a processing unit 73 and a storage unit 74. The processing unit 73 receives an information writing request from the information transmitting unit 72 of the information collecting device 61 via the communication network 64, and adds the monitoring information included in the received information writing request into a monitoring information table in the storage unit 74. When the processing unit 73 receives an information reading request from the monitoring processing device 63 via the communication network 64, the processing unit 73 reads information from the monitoring information table in the storage unit 74 according to the reading request, and transmits the read information to the monitoring processing device 63 via the communication network 64.

FIG. 3 is a diagram illustrating an example of the monitoring information table stored in the monitoring information storage device according to the first embodiment. The monitoring information table illustrated in FIG. 3 includes information in which a “monitoring information identifier ID” (ID: Identifier), a “measurement value”, a “measurement time”, a “facility name”, and a “facility ID” are associated with one another. The “monitoring information ID” is identification information of the measurement target. The “measurement value” is information indicating a measurement value outputted from a state measuring device that measures the measurement target. The “measurement time” is information indicating the date and time at which the measurement value is obtained. The “facility name” is information indicating the name of the facility 2. The “facility ID” is identification information for identifying the facility 2. The monitoring information table illustrated in FIG. 3 includes monitoring information in which the monitoring information ID “D0001”, the measurement value “100.0”, the measurement time “2018/01/01 12:00”, the facility name “facility A”, and the facility ID “E001” are associated with one another, for example.

Let us now return to FIG. 2 to continue the explanation of the remote monitoring device 6. The monitoring processing device 63 of the remote monitoring device 6 includes a failure information acquisition unit 75, a display information generation unit 76, and an information distribution unit 77. The failure information acquisition unit 75 acquires failure information from the failure detection device 8. The failure information includes information indicating a failure detail of the remote monitoring system 3 and information indicating a failure cause of the remote monitoring system 3. In the following description, examples provided in which the failure information includes information indicating a failure detail of the remote monitoring system 3 and information indicating a failure cause of the remote monitoring system 3, but these examples are not intended to limit the invention and the failure information may not include information indicating a failure cause of the remote monitoring system 3.

The display information generation unit 76 acquires the monitoring information from the monitoring information table in the monitoring information storage device 62 via the communication network 64, and generates, based on the acquired monitoring information, monitoring screen information which is information for making a display on the terminal device 5. The monitoring screen information is, for example, information on a graph in which change in the measurement value of the facility 2 is shown in chronological order, or information obtained by statistically processing the measurement value of the facility 2. The display information generation unit 76 can generate different pieces of monitoring screen information for the terminal devices 5, respectively.

The display information generation unit 76 also generates, based on the failure information, failure notification screen information which is information for displaying the failure information on the terminal device 5. The display information generation unit 76 can generate different pieces of failure notification screen information for the terminal devices 5, respectively. For example, the display information generation unit 76 generates failure notification screen information for the terminal device 5₁ including failure information on the information transmitting device 4₁ and the remote monitoring device 6. Further, the display information generation unit 76 generates failure notification screen information for the terminal device 5₂ including failure information on the information transmitting device 4₂ and the remote monitoring device 6. Further, the display information generation unit 76 generates failure notification screen information for the terminal device 5₃ including failure information on the information transmitting devices 4₁ and 4₂ and the remote monitoring device 6. In a case where the failure detection device 8 generates failure information narrowed down by notification information from the system administrator 13 as described later, the display information generation unit 76 can generate failure notification screen information including the failure information narrowed down by the notification information.

The information distribution unit 77 distributes, to the terminal device 5 via the communication network 9, the monitoring screen information and failure notification screen information generated by the display information generation unit 76. The information distribution unit 77 can distribute monitoring screen information to the terminal device 5 in response to a request from the terminal device 5 or periodically. Further, when the failure notification screen information is generated in the display information generation unit 76, the information distribution unit 77 distributes the failure notification screen information to the terminal device 5.

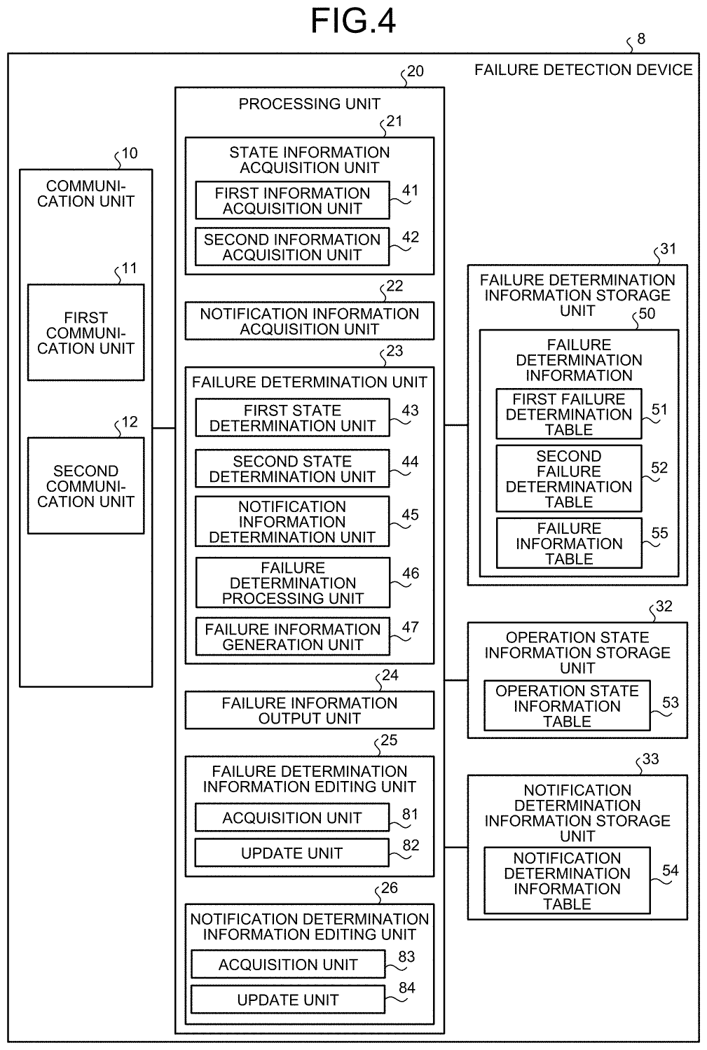

Next, the configuration of the failure detection device 8 will be described in more detail. FIG. 4 is a diagram illustrating a specific configuration example of the failure detection device according to the first embodiment. As illustrated in FIG. 4, the failure detection device 8 includes a communication unit 10, a processing unit 20, a failure determination information storage unit 31, an operation state information storage unit 32, and a notification determination information storage unit 33.

The failure determination information storage unit 31 stores failure determination information 50. The failure determination information 50 includes a first failure determination table 51, a second failure determination table 52, and a failure information table 55. The operation state information storage unit 32 stores an operation state information table 53. The notification determination information storage unit 33 stores a notification determination information table 54. Note that the notification determination information table 54 is an example of notification determination information.

The communication unit 10 includes a first communication unit 11 connected to the communication network 64 and a second communication unit 12 connected to the communication network 9. The processing unit 20 can communicate with the information collecting device 61, the monitoring information storage device 62, and the monitoring processing device 63 via the first communication unit 11, and communicate with the terminal device 5 via the second communication unit 12.

The processing unit 20 includes the state information acquisition unit 21, a notification information acquisition unit 22, the failure determination unit 23, the failure information output unit 24, a failure determination information editing unit 25, and a notification determination information editing unit 26.

The state information acquisition unit 21 includes a first information acquisition unit 41 and a second information acquisition unit 42. The first information acquisition unit 41 acquires monitoring information and state information from the information transmitting unit 72 of the information collecting device 61 via the communication network 64. The state information includes information indicating the operation state of the information transmitting device 4.

The second information acquisition unit 42 accesses the information collecting device 61, the monitoring information storage device 62, and the monitoring processing device 63 via the first communication unit 11 and the communication network 64 to acquire state information indicating the state of each of the information collecting device 61, the monitoring information storage device 62, and the monitoring processing device 63. Each of the information collecting device 61, the monitoring information storage device 62, and the monitoring processing device 63 stores an operation log that is a history of the operation state of the device. The second information acquisition unit 42 acquires an operation log from each of the information collecting device 61, the monitoring information storage device 62, and the monitoring processing device 63, and acquires the above-described state information from the acquired operation log.

The notification information acquisition unit 22 acquires the notification information transmitted from the terminal device 5 via the communication network 9 and the second communication unit 12. The notification information includes information indicating a detail of the failure. For example, the notification information is information indicating that the information transmitting device 4 has been shut down, information indicating that the information transmitting device 4 is abnormal, or information indicating that the facility 2 is normal but the monitoring screen to be displayed on the terminal device 5 has not been normally displayed.

The notification information is transmitted from the terminal device 5₃ to the failure detection device 8 via the communication network 9 when the system administrator 13 inputs the notification information to the terminal device 5₃ based on communication from the site worker 7. Further, the site workers 7₁ and 7₂ can input the notification information to the terminal devices 5₁ and 5₂ they hold to thereby transmit the notification information from the terminal devices 5₁ and 5₂ to the failure detection device 8 via the communication network 9.

The failure determination unit 23 includes a first state determination unit 43, a second state determination unit 44, a notification information determination unit 45, a failure determination processing unit 46, and a failure information generation unit 47. The first state determination unit 43 determines the state of the information transmitting device 4 based on the state information and monitoring information acquired by the first information acquisition unit 41 and the first failure determination table 51 stored in the failure determination information storage unit 31.

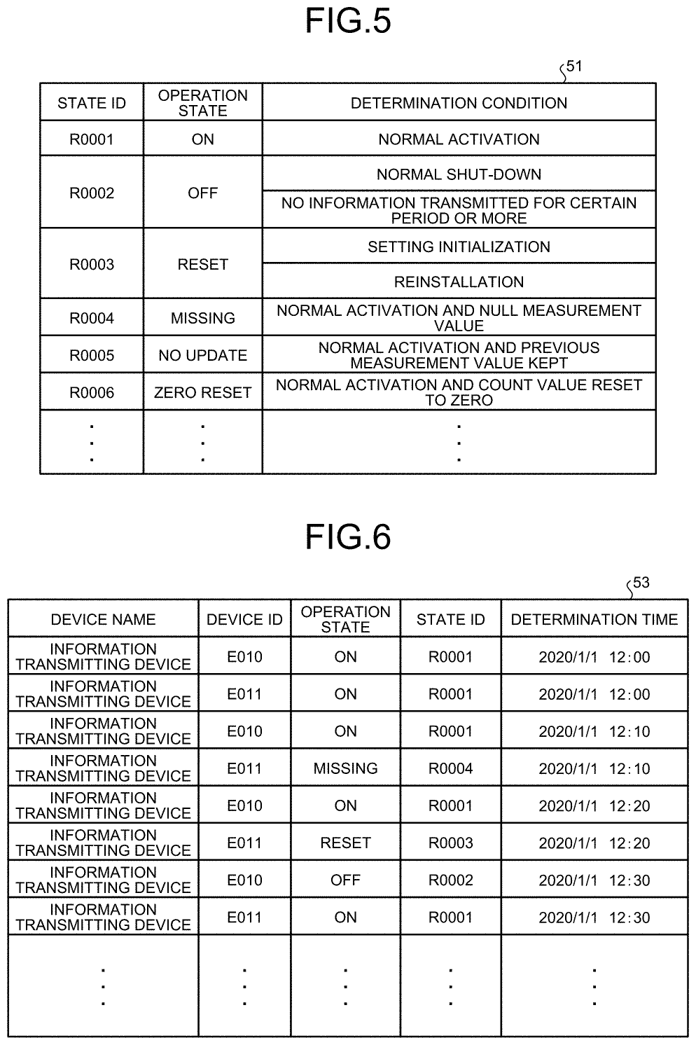

FIG. 5 is a diagram illustrating an example of the first failure determination table stored in the failure determination information storage unit according to the first embodiment. As illustrated in FIG. 5, the first failure determination table 51 includes information in which a “state ID” is associated with an “operation state” and a “determination condition”, for each “state ID”. The “state ID” is identification information indicating the type of an operation state of the information transmitting device 4.

The “operation state” is information indicating the type of an operation state of the information transmitting device 4. The operation state “ON” indicates a state in which the information transmitting device 4 has been activated normally. The operation state “OFF” indicates a state in which the information transmitting device 4 has been shut down. The operation state “RESET” indicates a state in which the information transmitting device 4 has been reset. The operation state “missing” indicates a state in which monitoring information that does not include a measurement value has been transmitted from the information transmitting device 4 to the remote monitoring device 6. The operation state “no update” indicates a state in which the measurement value included in the monitoring information transmitted from the information transmitting device 4 has not been updated yet. The operation state “zero reset” indicates a state in which the count value included in the monitoring information transmitted from the information transmitting device 4 has been reset to zero.

The “determination condition” is information indicating a condition for determining the type of a state of the information transmitting device 4. Based on the state information of the information transmitting device 4 or the monitoring information and state information of the information transmitting device 4, the first state determination unit 43 determines whether or not there is a determination condition that the state of the information transmitting device 4 satisfies. The first state determination unit 43 determines that the operation state associated with the determination condition satisfied by the state of the information transmitting device 4 is the state of the information transmitting device 4.

Here, it is assumed that the first failure determination table 51 is in a situation illustrated in FIG. 5. When the state information of the information transmitting device 4 is information indicating that the information transmitting device 4 has been activated normally, the first state determination unit 43 determines that the state of the information transmitting device 4 is an operation state “ON”. When the state information of the information transmitting device 4 is information indicating that the information transmitting device 4 has been shut down normally, the first state determination unit 43 determines that the state of the information transmitting device 4 is an operation state “OFF”. When the first information acquisition unit 41 has been unable to acquire the state information and monitoring information of the information transmitting device 4 for a determined period or longer, the first state determination unit 43 determines that the state of the information transmitting device 4 is an operation state “OFF”.

When the state information of the information transmitting device 4 is information indicating that the settings of the information transmitting device 4 have been initialized, the first state determination unit 43 determines that the state of the information transmitting device 4 is an operation state “RESET”. When the state information of the information transmitting device 4 is information indicating that a software of the information transmitting device 4 has been reinstalled, the first state determination unit 43 determines that the state of the information transmitting device 4 is an operation state “RESET”.

Even when the first state determination unit 43 determines that the determination condition “normal activation” is satisfied, the first state determination unit 43 may not set the operation state “ON” based on the measurement value included in the monitoring information. Specifically, the first state determination unit 43 determines that the state of the information transmitting device 4 is the operation state “missing” if the monitoring information does not include any measurement values. If the measurement value included in the monitoring information is equal to the measurement value of the previous monitoring information, the first state determination unit 43 determines that the state of the information transmitting device 4 is an operation state “no update”.

If the count value included in the monitoring information is zero, the first state determination unit 43 determines that the state of the information transmitting device 4 is an operation state “zero reset”. Here, the counter for counting the count value is included in the information transmitting device 4, but instead, the counter may be included in the state measuring device. In this case, the information transmitting device 4 acquires the count value of the counter together with the measurement value from the state measuring device, and incorporates the acquired measurement value and count value into the monitoring information to transmit it to the remote monitoring device 6. The counter increments the count value each time the measurement value is measured or transmitted. Therefore, in a situation where the count value has returned to zero, it indicates that the counter has been reset.

When the first state determination unit 43 determines that the state of the information transmitting device 4 is a specific state, for example, determines that the state of the information transmitting device 4 is an operation state other than “ON”, the first state determination unit 43 notifies the notification information determination unit 45 of the state ID of the determined operation state. The state ID provided to the notification information determination unit 45 is an example of information on a failure.

Further, the first state determination unit 43 adds information including the state ID associated with the determination condition that the state of the information transmitting device 4 satisfies, to the operation state information table 53 in the operation state information storage unit 32. FIG. 6 is a diagram illustrating an example of the operation state information table stored in the operation state information storage unit according to the first embodiment.

As illustrated in FIG. 6, the operation state information table 53 includes information in which a “device name”, a “device ID”, an “operation state”, a “state ID”, and a “determination time” are associated with one another. The “device name” is information indicating the name of the information transmitting device 4. The “device ID” is identification information of the information transmitting device 4. The “operation state” is information indicating the type of an operation state of the information transmitting device 4. The “state ID” is identification information indicating the type of an operation state of the information transmitting device 4. The “determination time” is information indicating the time at which the operation state is determined.

The first state determination unit 43 can also determine a failure in the information transmitting device 4 when the operation state included in the operation state information table 53 is a specific state. For example, the first state determination unit 43 may determine that a state ID of the information transmitting device 4 in which the operation state “OFF” is continuous for a predetermined period or longer is the state ID “R1001” or “R1002” illustrated in FIG. 9.

Let us now return to FIG. 4 to continue the explanation of the failure determination unit 23. The second state determination unit 44 of the failure determination unit 23 determines the state of the remote monitoring device 6 based on the state information of the remote monitoring device 6 acquired by the second information acquisition unit 42 and the second failure determination table 52 stored in the failure determination information storage unit 31.

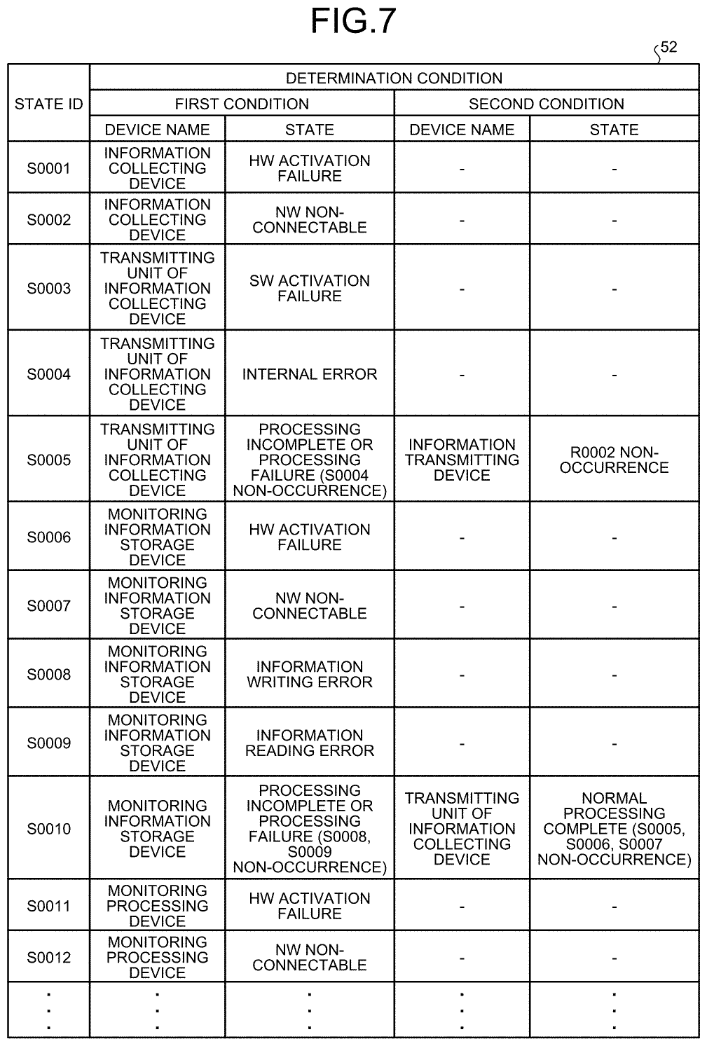

FIG. 7 is a diagram illustrating an example of the second failure determination table stored in the failure determination information storage unit according to the first embodiment. As illustrated in FIG. 7, the second failure determination table 52 includes information in which a “state ID” is associated with a “determination condition”, for each “state ID”.

The “state ID” is identification information indicating the type of a failure state of the remote monitoring device 6, and is an example of information on a failure. The “determination condition” is information indicating a condition for determining the type of a state of the remote monitoring device 6 from the state information of the remote monitoring device 6. The “determination condition” includes a “first condition” and a “second condition”. In a case where only the “first condition” is associated with the “state ID”, the type of a state of the remote monitoring device 6 is determined based on only the “first condition”. In a case where the “first condition” and the “second condition” are associated with the “state ID”, the type of a state of the remote monitoring device 6 is determined based on the “first condition” and the “second condition”.

Each of the “first condition” and the “second condition” is information in which a “device name” and a “state” are associated with each other. The “device name” is information that specifies one of the information collecting device 61, the monitoring information storage device 62, and the monitoring processing device 63 that constitute the remote monitoring device 6, and includes information that specifies a processing unit of the specified device. The “state” is information indicating a condition for the state of the device specified by the “device name”. Hereinafter, the device or processing unit specified by the “device name” may be referred to as a target device.

For example, a condition for the state “HW activation failure” is a state in which the hardware of the target device has not been activated normally. A condition for the state “NW non-connectable” is a state in which the target device is not communicably connected to the communication network 9 or the communication network 64. A condition for the state “SW activation failure” is a state in which the software of the target device has not been activated normally. A condition for the state “internal error” is a state in which an error has occurred inside the target device.

A condition for the state “processing incomplete or processing failure” is a state in which processing has not been completed or processing has failed in the target device. A condition for the state “information writing error” is a state in which information storage processing has failed in the target device. A condition for the state “information reading error” is a state in which information reading processing has failed in the target device.

Here, it is assumed that the second failure determination table 52 is in a situation illustrated in FIG. 7. For example, when the state information acquired by the second information acquisition unit 42 indicates that the information collecting device 61 has not been activated, the second state determination unit 44 determines that the determination condition for the state ID “S0001” is satisfied. For example, when the state information indicates that the information collecting device 61 can be accessed but information indicating activation is not transmitted from the information collecting device 61, the second state determination unit 44 determines that the information collecting device 61 has not been activated.

When the state information indicates that the information collecting device 61 has provided no response to access via the communication network 64, the second state determination unit 44 determines that the determination condition for the state ID “S0002” is satisfied. When the state information indicates that software activation has failed in the information collecting device 61, the second state determination unit 44 determines that the determination condition for the state ID “S0003” is satisfied. When the state information indicates an internal error of the information collecting device 61, the second state determination unit 44 determines that the determination condition for the state ID “S0004” is satisfied.

When the state information indicates that processing has been incomplete or failed in the information collecting device 61 but the state IDs “S0004” and “R0002” are not satisfied, the second state determination unit 44 determines that the determination condition for the state ID “S0005” is satisfied. Note that not satisfying the state ID “R0002” means that, for example, the determination time associated with the state ID “R0002” is not included a predetermined time before the time of determination of the second state determination unit 44 in the operation state information table 53.

When the state information indicates an error in the process of writing the monitoring information or when the state information indicates a failure in the process of storing the monitoring information, the second state determination unit 44 determines that the determination condition for the state ID “S0008” is satisfied. In addition, when the state information indicates an error in the process of reading the monitoring information, the second state determination unit 44 determines that the determination condition for the state ID “S0009” is satisfied. Similarly, the second state determination unit 44 can determine whether or not determination conditions for the state IDs “S0006”, “S0007”, “S0010”, “S0011”, “S0012”, and so on are satisfied based on the state information acquired by the second information acquisition unit 42.

Let us now return to FIG. 4 to continue the explanation of the failure determination unit 23. Based on the notification information acquired by the notification information acquisition unit 22 and the notification determination information table 54 stored in the notification determination information storage unit 33, the notification information determination unit 45 of the failure determination unit 23 selects a state ID related to the notification information.

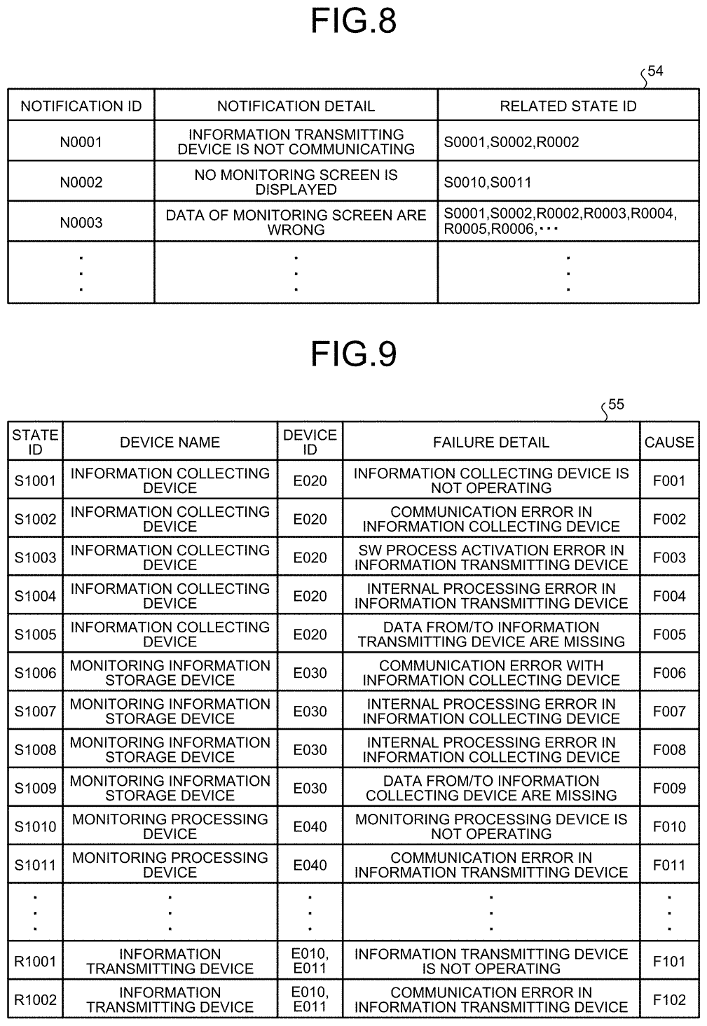

FIG. 8 is a diagram illustrating an example of the notification determination information table stored in the notification determination information storage unit according to the first embodiment. As illustrated in FIG. 8, the notification determination information table 54 stored in the notification determination information storage unit 33 includes information in which a “notification ID”, a “notification detail”, and a “related state ID” are associated with each other, for each “notification ID”. The “notification ID” is identification information uniquely assigned to each notification detail. The “notification detail” is information indicating the content provided in notification. The “related state ID” is information indicating a state ID related to the notification detail.

The notification information determination unit 45 searches the notification determination information table 54 for the notification detail that matches the notification information acquired by the notification information acquisition unit 22, and acquires a related state ID associated with the found notification detail obtained by the search from the notification determination information table 54. For example, when the notification information includes information that matches the notification detail “information transmitting device is not communicating”, the notification information determination unit 45 acquires the state IDs “S0001”, “S0002”, and “R0002” as related state IDs from the notification determination information table 54. Note that “matching the notification information” means substantially matching the notification information, and is not limited to completely matching the notification information. Further, the information transmitting device 4 can display, for example, that the information transmitting device 4 is currently operating and that the information transmitting device 4 is connected to the communication network 9 and is currently in a communicable state. The system administrator 13 or the site worker 7 can input the notification information to the terminal device 5 by checking a state displayed in the information transmitting device.

When the notification information includes information that matches the notification detail “no monitoring screen is displayed”, the notification information determination unit 45 acquires the state IDs “S0010” and “S0011” as related state IDs from the notification determination information table 54. When the notification determination information table 54 does not include information that matches the notification information, the notification information determination unit 45 selects a state unknown ID that is a state ID indicating that the state is unknown.

Let us now return to FIG. 4 to continue the explanation of the failure determination unit 23. The failure determination processing unit 46 of the failure determination unit 23 can determine the state ID to be provided to the failure information generation unit 47 based on one or more of the processing results of the first state determination unit 43, the second state determination unit 44, and the notification information determination unit 45. Hereinafter, when a state ID determined to satisfy a determination condition by the first state determination unit 43 and a state ID determined to satisfy a determination condition and to indicate a failure by the second state determination unit 44 are not individually distinguished from each other, they are referred to as a determination state ID or determination state IDs.

The process of state ID determination of the failure determination processing unit 46 is performed based on a set determination processing mode of a first determination processing mode and a second determination processing mode. The setting of a determination processing mode can be performed, for example, by the system administrator 13 operating the terminal device 5₃ and providing setting information, to the failure detection device 8 from the terminal device 5₃. The failure determination processing unit 46 of the failure detection device 8 executes the determination processing mode corresponding to the setting information from the terminal device 5₃.

First, the first determination processing mode will be described. In the first determination processing mode, when the notification information determination unit 45 does not acquire a related state ID or when the notification information determination unit 45 selects a state unknown ID, the failure determination processing unit 46 notifies the failure information generation unit 47 of a determination state ID.

When the notification information determination unit 45 acquires a related state ID, the failure determination processing unit 46 determines whether or not a determination state ID is included in the related state IDs. When a determination state ID is included in the related state IDs, the failure determination processing unit 46 selects the determination state ID included in the related state IDs. The failure determination processing unit 46 notifies the failure information generation unit 47 of the selected determination state ID. In response to determining that a determination state ID is not included in the related state IDs, the failure determination processing unit 46 notifies the failure information generation unit 47 of the related state ID.

In this way, the failure determination processing unit 46 selects the related state ID determined by the notification information determination unit 45 as a failure candidate for the remote monitoring system 3. Then, the failure determination processing unit 46 selects the determination state ID included in the related state IDs, and notifies the failure information generation unit 47 of the selected determination state ID. Consequently, failures in the remote monitoring system 3 can be narrowed down by communication from the site worker 7 or the system administrator 13, and the failure detection rate of the remote monitoring system 3 can be improved.

Next, the second determination processing mode will be described. In the second determination processing mode, the failure determination processing unit 46 determines the state ID to be provided to the failure information generation unit 47 based on the determination result of a determination state ID and a related state ID. For example, when there is a determination state ID and a related state ID, the failure determination processing unit 46 designates the determination state ID and the related state ID as the state IDs to be provided to the failure information generation unit 47. In addition, when there is only a determination state ID, the failure determination processing unit 46 provides only the determination state ID to the failure information generation unit 47. When there is only a related state ID, the failure determination processing unit 46 provides only the related state ID to the failure information generation unit 47.

Because a state ID that overlaps with both a related state ID and a determination state ID is considered to have high importance, the failure determination processing unit 46 can assign high priority in presentation order to the state ID that overlaps with both a related state ID and a determination state ID. Presentation order is the order of presentation to the site worker 7 or the system administrator 13, and is, for example, the order of arrangement in a failure information list. The failure information with high priority in presentation order is placed at a higher level of the failure information list. Further, when the notification information determination unit 45 acquires a related state ID, the failure determination processing unit 46 can also determine the state ID to be provided to the failure information generation unit 47 in the first determination processing mode, regardless of what the setting information is.

The failure information generation unit 47 extracts, from the failure information table 55 stored in the failure determination information storage unit 31, the failure detail associated with the state ID provided from the failure determination processing unit 46 of the failure determination unit 23. The failure information generation unit 47 generates failure information including the extracted failure detail. The failure information output unit 24 transmits the failure information generated by the failure information generation unit 47 to the monitoring processing device 63 via the communication network 64. Consequently, the monitoring processing device 63 can distribute the failure information including the failure detail to the terminal devices 5 via the communication network 9. Further, the failure information output unit 24 can directly transmit the failure information including the failure detail to the terminal device 5 via the communication network 9.

FIG. 9 is a diagram illustrating an example of the failure information table stored in the failure determination information storage unit according to the first embodiment. As illustrated in FIG. 9, the failure information table 55 includes information in which a “state ID”, a “device name”, a “device ID”, a “failure detail”, and “cause” are associated with each other for each “state ID”. The “device name” is information indicating the name of a device that constitutes the remote monitoring system 3. The “device ID” is identification information of a device that constitutes the remote monitoring system 3. The “failure detail” is information indicating the detail of a failure in the remote monitoring system 3. The “cause” is information indicating the cause of the failure in the remote monitoring system 3, and in the example illustrated in FIG. 9, includes information indicating the cause ID, but may be text information indicating a detail of the cause itself. A detail of the cause is, for example, information indicating the “state” illustrated in the second failure determination table 52.

For example, when the state ID provided by the failure determination unit 23 is “S1001”, the failure information generation unit 47 generates failure information including the failure detail “information collecting device is not operating”. When the state ID provided by the failure determination unit 23 is “S1005”, the failure information generation unit 47 generates failure information including the failure detail “data from/to information transmitting device are missing”. When the state ID provided by the failure determination unit 23 is “R1001”, the failure information generation unit 47 generates failure information including the failure detail “information transmitting device is not operating”.

Note that the failure information generation unit 47 can also generate failure information including the failure cause in addition to the failure detail. The failure information generation unit 47 can also generate failure information including information on a failure cause, for example, based on the “cause” included in the failure information table 55. For example, when the state ID provided by the failure determination processing unit 46 of the failure determination unit 23 is “R1001”, the failure information generation unit 47 generates failure information including text information indicating a detail of the cause “F101”.

Further, when there is a plurality of pieces of failure information generated, for example, the failure information generation unit 47 generates, based on the presentation order determined by the failure determination processing unit 46, a failure information list that is a list of failure information in which the plurality of pieces of failure information are ranked. Further, the failure determination information storage unit 31 can store a failure information order table (not illustrated) in which the order of state IDs is set for each combination of the state IDs. When the presentation order is not determined by the failure determination processing unit 46, the failure information generation unit 47 can also generate, based on the failure information order table set for a combination of the state IDs provided by the failure determination processing unit 46, a failure information list that is a list of failure information in which two or more pieces of failure information are ranked.

In this manner, when there is a plurality of failures in the remote monitoring system 3 determined by the failure determination processing unit 46, the failure information generation unit 47 can generate a failure information list in which the two or more determined failures are ranked and arranged accordingly.

Further, the failure information table 55 can include information in which two or more state IDs are associated with one failure detail. If there is one failure detail associated with two or more state IDs of a first state ID, a second state ID, and a related state ID, the failure information generation unit 47 can generate failure information including one failure detail. Consequently, it is possible to generate failure information including a detail of failures caused by two or more failures.

As described above, the failure detection device 8 can automatically collect the states of the remote monitoring system 3 including virtual devices such as the information collecting device 61, the monitoring information storage device 62, and the monitoring processing device 63 to detect a failure caused in the remote monitoring system 3, and can notify the terminal device 5 of the detected failure. Further, it is possible to notify the terminal device 5 of the failure details narrowed down by the notification information transmitted from the terminal device 5. Consequently, the site workers 7₂ and 7₂ can easily grasp the failure details that they want to know, and the failure detection rate of the failure detection device 8 can be improved.

Let us now return to FIG. 4 to continue the explanation of the failure detection device 8. The failure determination information editing unit 25 of the failure detection device 8 includes an acquisition unit 81 and an update unit 82. The acquisition unit 81 receives a first editing request from the terminal device 5 via the communication network 9 and the second communication unit 12, and acquires editing information included in the received first editing request. The editing information acquired by the acquisition unit 81 is information for editing the failure determination information 50. The update unit 82 edits the failure determination information 50 based on the editing information acquired by the acquisition unit 81.

As described above, the failure detection device 8 includes the failure determination information editing unit 25 that edits the failure determination information 50 based on an editing request from the terminal device 5. Therefore, for example, the system administrator 13 can add and change the content of the failure determination information 50 as needed. This enables the failure detection device 8 to detect a newly identified failure, and also enables the failure detection device 8 to detect information on a failure specific to each site.

The notification determination information editing unit 26 of the failure detection device 8 includes an acquisition unit 83 and an update unit 84. The acquisition unit 83 receives a second editing request from the terminal device 5 via the communication network 9 and the second communication unit 12, and acquires editing information included in the received second editing request. The editing information acquired by the acquisition unit 83 is information for editing the notification determination information table 54. The update unit 84 edits the notification determination information table 54 based on the editing information acquired by the acquisition unit 83.

As described above, the failure detection device 8 includes the notification determination information editing unit 26 that edits the notification determination information table 54 based on an editing request from the terminal device 5. Therefore, for example, the system administrator 13 can add and change the content of the notification determination information table 54 as needed. This enables the system administrator 13, for example, to reflect the tendency of failure details provided by the site workers 7₁ and 7₂ to the system administrator 13 in the notification determination information table 54, or to reflect notification details that suit the site environment in the notification determination information table 54.

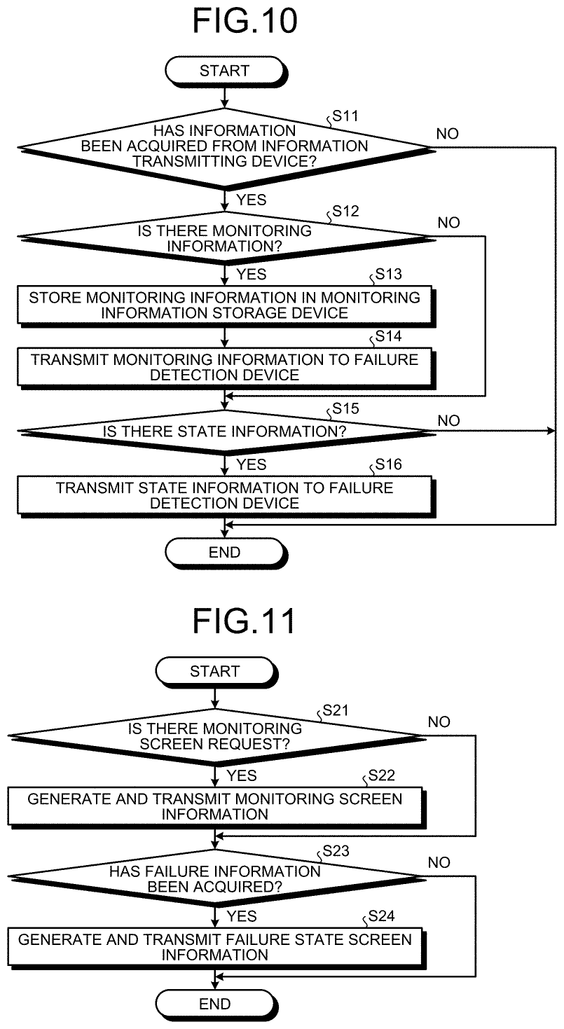

Next, the operation of the information collecting device 61 will be described using a flowchart. FIG. 10 is a flowchart illustrating an exemplary process that is performed by the information collecting device according to the first embodiment. As illustrated in FIG. 10, the information collecting device 61 determines whether or not information has been acquired from the information transmitting device 4 (step S11). In response to determining that the information has been acquired (step S11: Yes), the information collecting device 61 determines whether or not there is monitoring information in the acquired information (step S12). In response to determining that there is monitoring information (step S12: Yes), the information collecting device 61 stores the monitoring information in the monitoring information storage device 62 (step S13), and transmits the monitoring information to the failure detection device 8 (step S14).

In response to completing a process of step S14 or in response to determining that there is no monitoring information (step S12: No), the information collecting device 61 determines whether or not there is state information in the acquired information (step S15). In response to determining that there is state information (step S15: Yes), the information collecting device 61 transmits the state information to the failure detection device 8 (step S16). In response to determining that information has not been acquired (step S11: No), in response to determining that there is no state information (step S15: No), or in response to completing a process of step S16, the information collecting device 61 terminates the process illustrated in FIG. 10. Note that the process illustrated in FIG. 10 is repeatedly executed by the information collecting device 61.

Next, the operation of the monitoring processing device 63 will be described using a flowchart. FIG. 11 is a flowchart illustrating an exemplary process that is performed by the monitoring processing device according to the first embodiment. As illustrated in FIG. 11, the monitoring processing device 63 determines whether or not there is a monitoring screen request from the terminal device 5 (step S21). In response to determining that there is a monitoring screen request (step S21: Yes), the monitoring processing device 63 generates monitoring screen information, and transmits the generated monitoring screen information via the communication network 9 to the terminal device 5 that has issued the monitoring screen request (step S22).

In response to determining that there is no monitoring screen request (step S21: No) or in response to completing a process of step S22, the monitoring processing device 63 determines whether or not failure information has been acquired from the failure detection device 8 (step S23). In response to determining that failure information has been acquired (step S23: Yes), the monitoring processing device 63 generates failure state screen information based on the acquired failure information, and transmits the generated failure state screen information to the terminal device 5 (step S24).

In response to determining that failure information has not been acquired (step S23: No) or in response to completing a process of step S24, the monitoring processing device 63 terminates the process illustrated in FIG. 11. Note that the process illustrated in FIG. 11 is repeatedly executed by the monitoring processing device 63.

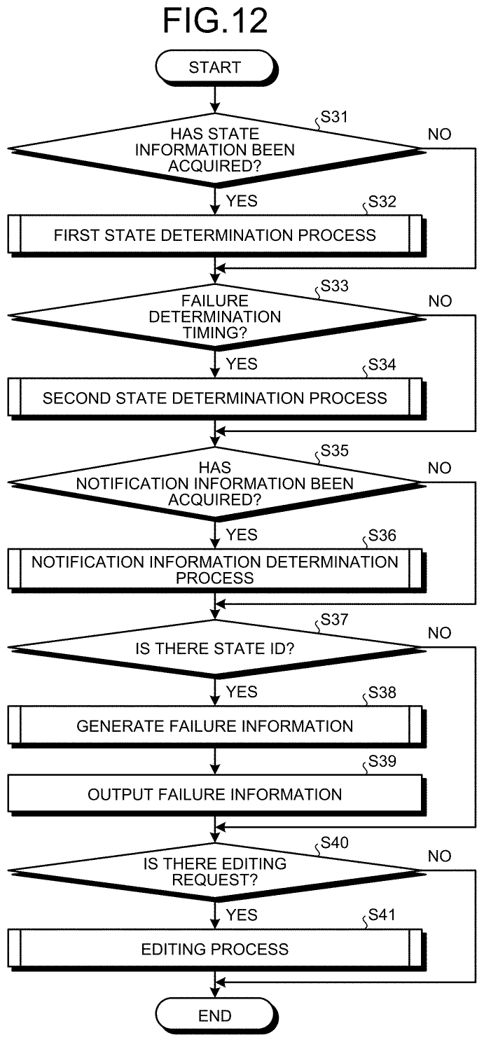

Next, the operation of the failure detection device 8 will be described using a flowchart. FIG. 12 is a flowchart illustrating an exemplary process that is performed by the failure detection device according to the first embodiment. As illustrated in FIG. 12, the processing unit 20 of the failure detection device 8 determines whether or not state information has been acquired from the information collecting device 61 (step S31). In response to determining that the state information has been acquired (step S31: Yes), the processing unit 20 performs a first state determination process described later (step S32).

In response to determining that the state information has not been acquired (step S31: No) or in response to completing a process of step S32, the processing unit 20 determines whether or not the failure determination timing has come (step S33). In step S33, the processing unit 20 can determine that the failure determination timing has come when acquiring notification information from the terminal device 5. Alternatively, the processing unit 20 can determine that the failure determination timing has come, for example, at regular intervals.

In response to determining that the failure determination timing has come (step S33: Yes), the processing unit 20 performs a second state determination process described later (step S34). In response to determining that the failure determination timing has not come (step S33: No) or in response to completing a process of step S34, the processing unit 20 determines whether or not the notification information has been acquired (step S35). In response to determining that the notification information has been acquired (step S35: Yes), the processing unit 20 performs a notification information determination process described later (step S36).

In response to determining that the notification information has not been acquired (step S35: No) or in response to completing a process of step S36, the processing unit 20 determines whether or not there is a state ID determined in step S32, S34, or S36 (step S37). In response to determining that there is a state ID (step S37: Yes), the processing unit 20 performs a failure information generation process described later (step S38). The processing unit 20 outputs the failure information generated in step S38 to the monitoring processing device 63 (step S39).

In response to determining that there is no state ID (step S37: No) or in response to completing a process of step S39, the processing unit 20 determines whether or not there is an editing request from the terminal device 5 (step S40). In response to determining that there is an editing request (step S40: Yes), the processing unit 20 performs an editing process described later (step S41). In response to determining that there is no editing request (step S40: No) or in response to completing a process of step S41, the processing unit 20 terminates the process illustrated in FIG. 12. Note that the process illustrated in FIG. 12 is repeatedly executed by the processing unit 20.

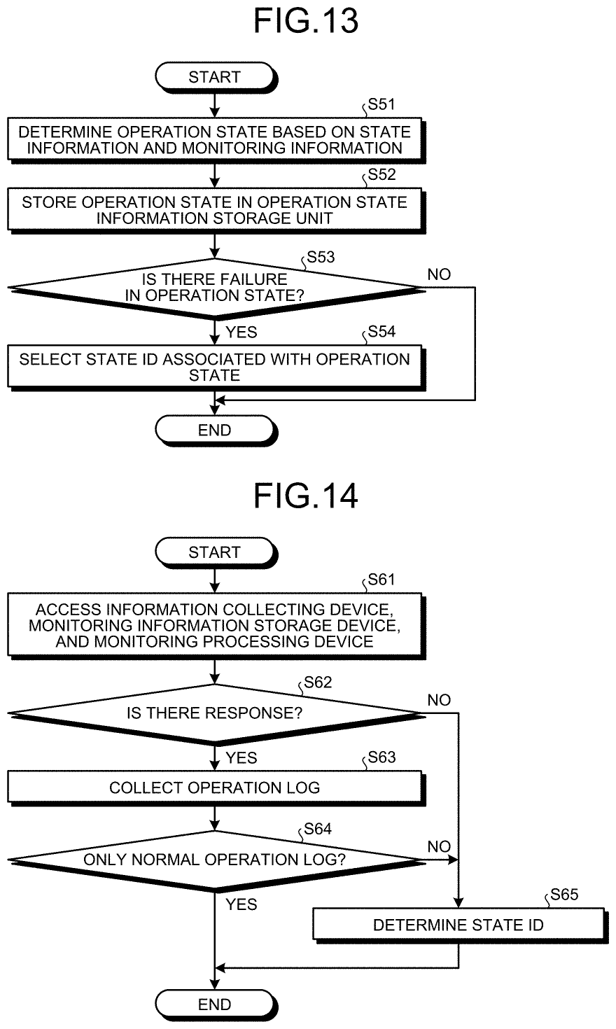

FIG. 13 is a flowchart illustrating an example of a process of step S32 illustrated in FIG. 12. As illustrated in FIG. 13, the failure determination unit 23 of the processing unit 20 determines the operation state based on the acquired state information and monitoring information (step S51). Specifically, the failure determination unit 23 determines the operation state of the information transmitting device 4 based on the acquired state information and monitoring information and the first failure determination table 51.

Next, the failure determination unit 23 stores information on the determined operation state of the information transmitting device 4 in the operation state information storage unit 32 (step S52), and determines whether or not there is a failure in the operation state of the information transmitting device 4 (step S53). For example, in a case where the first failure determination table 51 is in the state illustrated in FIG. 5, when the operation state of the information transmitting device 4 is other than “ON”, the failure determination unit 23 determines that there is a failure in the operation state of the information transmitting device 4. In response to determining that there is a failure in the operation state of the information transmitting device 4 (step S53: Yes), the failure determination unit 23 selects the state ID associated with the operation state of the information transmitting device 4 from the first failure determination table 51 (step S54). In response to determining that there is no failure in the operation state of the information transmitting device 4 (step S53: No) or in response to completing a process of step S54, the failure determination unit 23 terminates the process illustrated in FIG. 13.

FIG. 14 is a flowchart illustrating an example of a process of step S34 illustrated in FIG. 12. As illustrated in FIG. 14, the state information acquisition unit 21 of the processing unit 20 accesses each of the information collecting device 61, the monitoring information storage device 62, and the monitoring processing device 63 (step S61). The processing unit 20 performs processes on or after step S62 for each of the information collecting device 61, the monitoring information storage device 62, and the monitoring processing device 63. Hereinafter, a processing target device for the processes on or after step S62 will be referred to as a target device.

In step S62, the state information acquisition unit 21 determines whether or not there is a response from the target device (step S62). In response to determining that there is a response (step S62: Yes), the processing unit 20 collects operation logs from the target device (step S63). The failure determination unit 23 determines whether or not the collected operation logs cover only a log indicating a normal operation (step S64).

When it is determined that there is no response (step S62: No) or when it is determined that the collected operation logs cover a log other than the log indicating a normal operation (step S64: No), the failure determination unit 23 determines the state ID based on the second failure determination table 52 (step S65). In response to determining that the collected operation logs cover only the log indicating a normal operation (step S64: Yes) or in response to completing a process of step S65, the failure determination unit 23 terminates the process illustrated in FIG. 14.

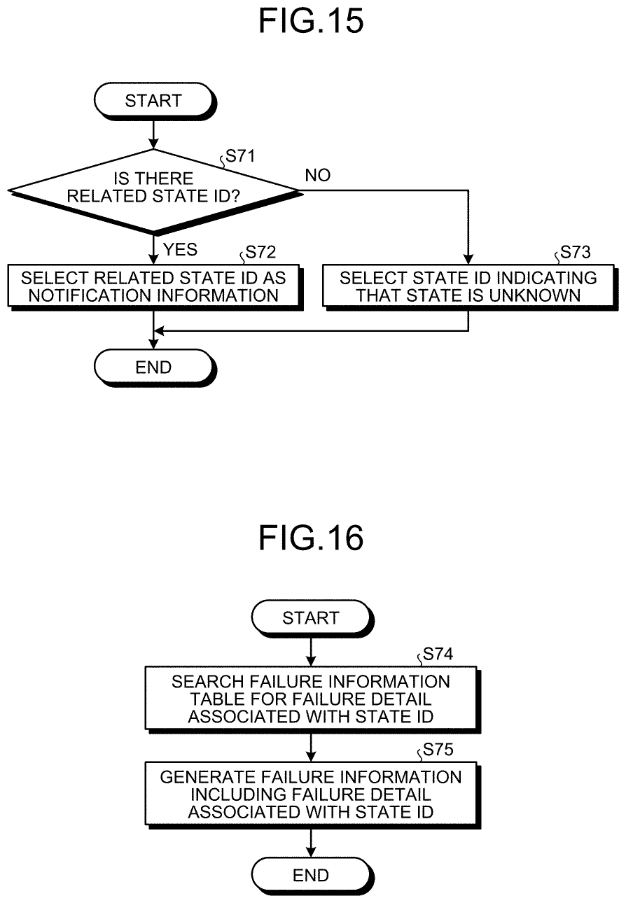

FIG. 15 is a flowchart illustrating an example of a process of step S36 illustrated in FIG. 12. As illustrated in FIG. 15, the failure determination unit 23 of the processing unit 20 determines, based on the acquired notification information and the notification determination information table 54, whether or not there is a related state ID that is a state ID related to the notification information (step S71).

In response to determining that there is a related state ID (step S71: Yes), the failure determination unit 23 selects the related state ID from the notification determination information table 54 (step S72). In response to determining that there is no related state ID (step S71: No), the failure determination unit 23 selects a state unknown ID that is a state ID indicating that the state is unknown (step S73). In response to completing a process of step S72 or a process of step S73, the failure determination unit 23 terminates the process illustrated in FIG. 15.

FIG. 16 is a flowchart illustrating an example of a process of step S38 illustrated in FIG. 12. As illustrated in FIG. 16, the failure determination unit 23 searches the failure information table 55 for the failure detail associated with the state ID determined or selected in the above-described processes (step S74). Then, the processing unit 20 generates failure information including the failure detail associated with the state ID (step S75), and terminates the process illustrated in FIG. 16.

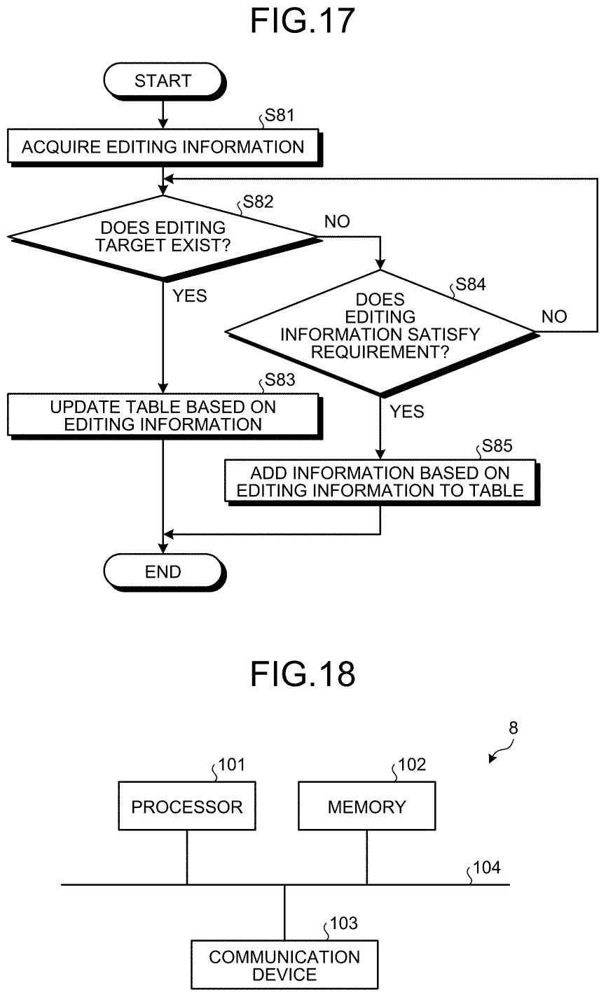

FIG. 17 is a flowchart illustrating an example of a process of step S41 illustrated in FIG. 12. As illustrated in FIG. 17, the processing unit 20 acquires editing information included in the editing request (step S81), and determines whether or not an editing target specified by the editing information exists (step S82).

In step S82, in a case where the editing information acquired in step S81 is editing information included in the first editing request, if the failure information to be edited based on the editing information already exists in the failure determination information 50, the processing unit 20 determines that the editing target exists. In a case where the editing information acquired in step S81 is editing information included in the second editing request, if information including the notification detail to be edited based on the editing information already exists in the notification determination information table 54, the processing unit 20 determines that the editing target exists.

In response to determining that the editing target exists (step S82: Yes), the processing unit 20 updates the table on the basis of the editing information (step S83). For example, in a case where the editing information is editing information included in the first editing request, the processing unit 20 changes the content of the failure determination information 50 to update the failure determination information 50. In a case where the editing information is editing information included in the second editing request, the processing unit 20 changes the content of the notification determination information table 54 to update the notification determination information table 54.

In response to determining that the editing target does not exist (step S82: No), the processing unit 20 determines whether or not the editing information acquired in step S81 is editing information that satisfies a requirement for adding some information to the table (step S84). In response to determining that the editing information does not satisfy the requirement (step S84: No), the processing unit 20 returns the process to step S82.

In response to determining that the editing information satisfies the requirement (step S84: Yes), the processing unit 20 adds some information that is based on the editing information to the table (step S85). For example, in a case where the editing information is editing information included in the first editing request, the processing unit 20 adds failure information that is based on the editing information to the failure determination information 50. In a case where the editing information is editing information included in the second editing request, the processing unit 20 adds information including the notification detail that is based on the editing information to the notification determination information table 54. In response to completing a process of step S83 or a process of step S85, the processing unit 20 terminates the process illustrated in FIG. 17.

Although the above-described failure determination information 50 is divided into the first failure determination table 51, the second failure determination table 52, and the failure information table 55, the failure determination information 50 is not limited to the above-described example. That is, the failure determination information 50 only needs to enable failure information of the remote monitoring system 3 to be generated based on state information, and may include two or less tables or four or more tables. The failure determination information 50 may be any information as long as the above-described determination conditions and failure details are finally associated with each other, and is not limited to the above-described example.

The first information acquisition unit 41 can directly acquire the operation log of the information transmitting device 4 from the information transmitting device 4 by accessing the information transmitting device 4 via the communication network 9. In this case, the first information acquisition unit 41 accesses the information transmitting device 4 via the communication network 9. When the information transmitting device 4 is not activated, the first state determination unit 43 can determine that the determination condition for the state ID “S0001” illustrated in FIG. 7 is satisfied. The first state determination unit 43 can determine that the determination condition for the state ID “S0002” illustrated in FIG. 7 is satisfied, for example, when receiving a response from the information transmitting device 4 upon access to the information transmitting device 4 but being unable to acquire an operation log.

Here, a hardware configuration of the failure detection device 8 according to the first embodiment will be described. FIG. 18 is a diagram illustrating an exemplary hardware configuration of the failure detection device according to the first embodiment. As illustrated in FIG. 18, the failure detection device 8 includes a processor 101, a memory 102, and a communication device 103. The processor 101, the memory 102, and the communication device 103 can exchange data with one another via a bus 104. The communication unit 10 of the failure detection device 8 is implemented by the communication device 103. The failure determination information storage unit 31, the operation state information storage unit 32, and the notification determination information storage unit 33 of the failure detection device 8 are implemented by the memory 102. The memory 102 includes a recording medium on which a computer-readable program is recorded.

The processor 101 reads and executes a program stored in the memory 102 to thereby execute the functions of the state information acquisition unit 21, the notification information acquisition unit 22, the failure determination unit 23, the failure information output unit 24, the failure determination information editing unit 25, and the notification determination information editing unit 26 described above. The processor 101 is an example of a processing circuit, and includes one or more of a central processing unit (CPU), a digital signal processor (DSP), and a system large scale integration (LSI), for example. Examples of the memory 102 include a non-volatile or volatile semiconductor memory, a magnetic disk, a flexible disk, an optical disc, a compact disc, a mini disc, a digital versatile disk (DVD), and the like. Examples of the non-volatile or volatile semiconductor memory include a random access memory (RAM), a read only memory (ROM), a flash memory, an erasable programmable read only memory (EPROM), an electrically erasable programmable read-only memory (EEPROM), and the like.

As described above, the failure detection device 8 according to the first embodiment includes the state information acquisition unit 21, the failure determination unit 23, and the failure information output unit 24. The state information acquisition unit 21 acquires, from the remote monitoring system 3 that monitors the facility 2 provided in a remote location, state information indicating the state of the remote monitoring system 3. The failure determination unit 23 determines a failure in the remote monitoring system 3 based on the state information acquired by the state information acquisition unit 21, and generates failure information indicating a detail of the determined failure. The failure information output unit 24 outputs the failure information generated by the failure determination unit 23. Consequently, the state of the remote monitoring system 3 can be automatically collected, so that the burden on the system administrator 13 can be reduced when a failure occurs in the remote monitoring system 3.

The failure detection device 8 includes the failure determination information storage unit 31 that stores the failure determination information 50 including information in which a determination condition that is a condition for the state of the remote monitoring system 3 and a state ID or failure detail that is information on a failure in the remote monitoring system 3 are associated with each other for each determination condition. The state information acquisition unit 21 acquires state information indicating the operation state of each of the information transmitting device 4, the information collecting device 61, the monitoring information storage device 62, and the monitoring processing device 63, which constitute the remote monitoring system 3. The failure determination unit 23 determines a failure in each of the information transmitting device 4, the information collecting device 61, the monitoring information storage device 62, and the monitoring processing device 63 based on the state information acquired by the state information acquisition unit 21 and the failure determination information 50 stored in the failure determination information storage unit 31. In this manner, the failure detection device 8 determines a failure in the devices constituting the remote monitoring system 3 on the basis of the information stored in the failure determination information storage unit 31, so that the failure determination can be easily performed.

The failure detection device 8 includes the failure determination information editing unit 25 that edits the failure determination information 50. The failure determination information editing unit 25 includes the acquisition unit 81 that acquires editing information for editing the failure determination information 50 and the update unit 82 that updates the failure determination information 50 based on the editing information acquired by the acquisition unit 81. Therefore, for example, the system administrator 13 can edit the failure determination information 50, so that a newly identified failure pattern, information on a failure specific to a site, and the like can be reflected in the first failure determination table 51, the second failure determination table 52, and the failure information table 55.

The failure detection device 8 also includes the notification determination information storage unit 33 that stores the notification determination information table 54 including information in which information indicating a failure detail of the facility 2 and information on a failure in the remote monitoring system 3 are associated with each other, and the notification information acquisition unit 22 that acquires, from the terminal device 5, notification information including information indicating a failure detail of the remote monitoring system 3. The failure determination unit 23 selects failure candidates for the remote monitoring system 3 based on the notification information received by the notification information acquisition unit 22 and the notification determination information table 54, and determines a failure in the remote monitoring system 3 from the selected failure candidates on the basis of the state information acquired by the state information acquisition unit 21. Consequently, failures caused in the remote monitoring system 3 can be narrowed down by communication from the site worker 7 or the system administrator 13, and the failure detection rate of the remote monitoring system 3 can be improved.

The failure detection device 8 also includes the notification determination information editing unit 26 that edits the notification determination information table 54. The notification determination information editing unit 26 includes the acquisition unit 83 that acquires editing information for editing the notification determination information table 54 and the update unit 84 that updates the notification determination information table 54 based on the editing information acquired by the acquisition unit 83. With this configuration, for example, the tendency of failure details provided by the site worker 7 to the system administrator 13 can be reflected in the notification determination information table 54, and/or notification details that suit the site environment can be reflected in the notification determination information table 54.

When two or more failures in the remote monitoring system 3 are determined by the failure determination unit 23, the failure information output unit 24 generates a failure information list in which the two or more determined failures are ranked and arranged accordingly, and outputs the generated failure information list. Consequently, for example, a failure information list in which two or more failures are arranged in order according to failure importance is generated, thereby making it possible to improve convenience for the site worker 7 and the system administrator 13.

### Second Embodiment

The second embodiment is different from the first embodiment in that a process for estimating a failure detail is added. In the following description, components having the same functions as those in the first embodiment are denoted by the same reference signs, and descriptions thereof are omitted. The difference from the failure detection device 8 according to the first embodiment is mainly described.

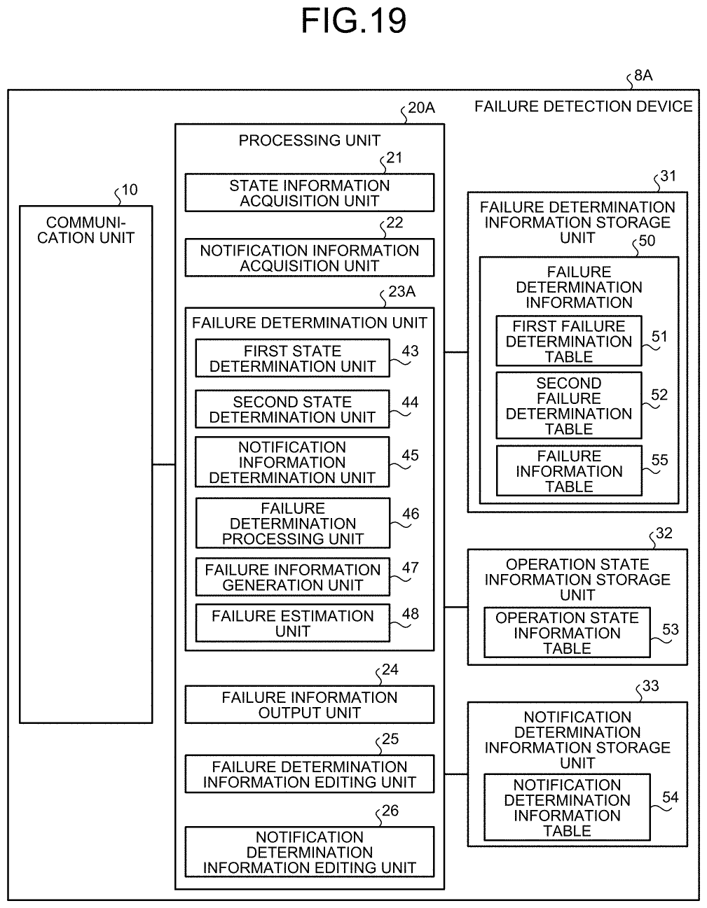

FIG. 19 is a diagram illustrating an exemplary configuration of a failure detection device according to the second embodiment. As illustrated in FIG. 19, the failure detection device 8A according to the second embodiment is different from the failure detection device 8 in that a processing unit 20A is provided instead of the processing unit 20 of the failure detection device 8. The processing unit 20A is different from the processing unit 20 in that a failure determination unit 23A is provided instead of the failure determination unit 23.

The failure determination unit 23A includes a failure estimation unit 48 in addition to the components of the failure determination unit 23. The failure estimation unit 48 estimates a failure in the remote monitoring system 3 when the failure detail and cause associated with the state ID provided by the failure determination processing unit 46 are not in the failure information table 55. Specifically, the failure estimation unit 48 determines, using the state ID provided by the failure determination processing unit 46 and the state ID included in the failure information table 55, the failure detail and cause related to the state ID provided by the failure determination processing unit 46.

For example, the failure estimation unit 48 extracts information on the determination condition associated with the state ID provided by the failure determination processing unit 46 as first information from the first failure determination table 51 or the second failure determination table 52. The failure estimation unit 48 also extracts information on the determination condition associated with each state ID included in the failure information table 55 as second information from the first failure determination table 51 or the second failure determination table 52.

The failure estimation unit 48 calculates the degree of similarity between the first information and each piece of the second information using a preset algorithm, and determines the second information piece whose degree of similarity to the first information is equal to or greater than a threshold value. Note that the failure estimation unit 48 includes a table in which the degree of similarity between the first information and each piece of the second information is set in advance, and can determine the degree of similarity between the first information and each piece of the second information on the basis of that table.

The failure estimation unit 48 acquires, from the first failure determination table 51 or the second failure determination table 52, the state ID associated with the second information piece whose degree of similarity to the first information is equal to or greater than the threshold value, thereby estimating a failure detail. The state ID extracted by the failure estimation unit 48 is associated with a failure detail in the failure information table 55, and is provided by the failure estimation unit 48 to the failure information generation unit 47. The failure information generation unit 47 extracts, from the failure information table 55, failure information including the failure detail and cause associated with the state ID provided by the failure estimation unit 48, and incorporates the extracted failure information in the failure information list as similar failure information.

When the failure detail and cause associated with the state ID provided by the failure determination processing unit 46 is in the failure information table 55, the failure information generation unit 47 extracts the failure detail and cause from the failure information table 55, and incorporates failure information including the extracted failure detail and cause into the failure information list. The failure information output unit 24 outputs the failure information list generated by the failure determination unit 23A to the monitoring processing device 63.

In this manner, the failure detection device 8 according to the second embodiment can estimate a failure detail, and accordingly it is possible to provide notification of not only the failure information that completely matches the failure information table 55 but also an unknown failure. Therefore, even when there are many unknown failures in the remote monitoring system 3, the system administrator 13 can be assisted in investigating the cause thereof.

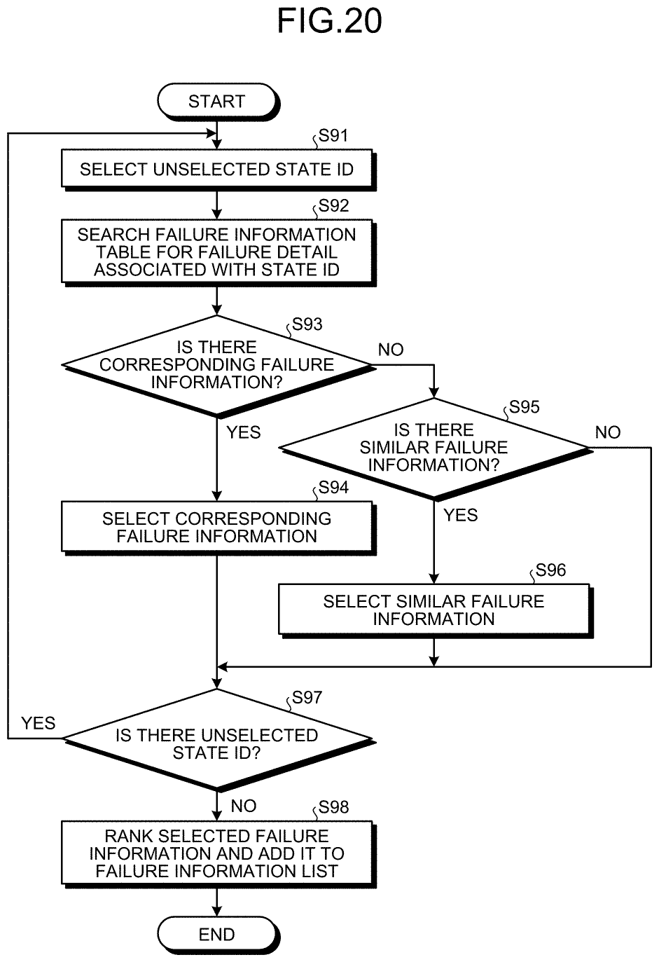

FIG. 20 is a flowchart illustrating an exemplary process that is performed by the failure detection device according to the second embodiment, which corresponds to a process of step S38 illustrated in FIG. 12. As illustrated in FIG. 20, the failure determination unit 23A of the processing unit 20A selects, as a selected state ID, an unselected state ID from among the state IDs provided by the failure determination processing unit 46 (step S91), and searches the failure information table 55 for the failure detail associated with the selected state ID (step S92).

The failure determination unit 23A determines whether or not there is failure information concerned (step S93). In step S93, when there is a failure detail associated with the selected state ID in the failure information table 55, the failure determination unit 23A determines that there is failure information concerned.

In response to determining that there is failure information concerned (step S93: Yes), the failure determination unit 23A selects the corresponding failure information (step S94). In response to determining that there is no failure information concerned (step S93: No), the failure determination unit 23A determines whether or not there is similar failure information (step S95). In response to determining that there is the similar failure information (step S95: Yes), the failure determination unit 23A selects the similar failure information (step S96).

In response to completing a process of step S94, in response to determining that there is no similar failure information (step S95: No), or in response to completing a process of step S96, the failure determination unit 23A determines whether or not there is an unselected state ID (step S97). In response to determining that there is an unselected state ID (step S97: Yes), the failure determination unit 23A shifts the process to step S91. In response to determining that there is no unselected state ID (step S97: No), the failure determination unit 23A ranks the selected failure information and adds it to the failure information list (step S98), and terminates the process illustrated in FIG. 20. For example, the failure determination unit 23A generates a failure information list in which the failure information selected in step S94 has higher priority in presentation order than the failure information selected in step S95.

Note that the failure determination unit 23A can use a process similar to the above-described process to perform failure estimation for state information from which the state of the information transmitting device 4 cannot be determined by the first state determination unit 43 and state information from which the state of the remote monitoring device 6 cannot be determined by the second state determination unit 44.

An exemplary hardware configuration of the failure detection device 8A according to the second embodiment is the same as that of the failure detection device 8 illustrated in FIG. 18. The processor 101 can execute the function of the failure determination unit 23A by reading and executing a program stored in the memory 102.

As described above, in a case where information on the failure associated with the state information is not included in the failure determination information 50, the failure estimation unit 48 of the failure detection device 8A according to the second embodiment estimates a failure in the remote monitoring system 3 based on information on the failure associated with a state having a higher degree of similarity to the state information, among the determination conditions included in the failure determination information 50. Consequently, it is possible to provide notification of not only the failure information that completely matches the failure information table 55 but also an unknown failure.

The configurations described in the above-mentioned embodiments indicate examples of the contents of the present invention, each of which can be combined with other publicly known techniques and partially omitted and/or modified in a range not departing from the gist of the present invention.

### REFERENCE SIGNS LIST

1 monitoring control system; 2, 2₁ to 2₆ facility; 3 remote monitoring system; 4, 4₁, 4₂ information transmitting device; 5, 5₁, 5₂, 5₃ terminal device; 6 remote monitoring device; 7, 7₁, 7₂ site worker; 8, 8A failure detection device; 9, 64 communication network; 10 communication unit; 11 first communication unit; 12 second communication unit; 13 system administrator; 20, 20A processing unit; 21 state information acquisition unit; 22 notification information acquisition unit; 23, 23A failure determination unit; 24 failure information output unit; 25 failure determination information editing unit; 26 notification determination information editing unit; 31 failure determination information storage unit; 32 operation state information storage unit; 33 notification determination information storage unit; 41 first information acquisition unit; 42 second information acquisition unit; 43 first state determination unit; 44 second state determination unit; 45 notification information determination unit; 46 failure determination processing unit; 47 failure information generation unit; 48 failure estimation unit; 51 first failure determination table; 52 second failure determination table; 53 operation state information table; notification determination information table; 55 failure information table; 61 information collecting device; 62 monitoring information storage device; 63 monitoring processing device; 71 information acquisition unit; 72 information transmitting unit; 73 processing unit; 74 storage unit; 75 failure information acquisition unit; 76 display information generation unit; 77 information distribution unit; 81, 83 acquisition unit; 82, update unit.

1. A failure detection device comprising:
a state information acquisition unit to acquire, from a remote monitoring system that monitors a facility provided in a remote location, state information indicating a state of the remote monitoring system;
a notification determination information storage unit to store notification determination information including information in which information indicating a failure detail of the facility is associated with information on a failure in the remote monitoring system;
a notification information acquisition unit to acquire, from a terminal device, notification information including information indicating a failure detail of the facility,
a failure determination unit to select failure candidates for the remote monitoring system based on the notification information received by the notification information acquisition unit and the notification determination information, determine a failure in the remote monitoring system from the failure candidates based on the state information acquired by the state information acquisition unit, and generate failure information indicating a detail of the failure determined; and
a failure information output unit to output the failure information generated by the failure determination unit.

2. The failure detection device according to claim 1, comprising
a failure determination information storage unit to store failure determination information including information in which a condition for the state of the remote monitoring system and information on a failure in the remote monitoring system are associated with each other, on the condition basis, wherein
the state information acquisition unit acquires, as the state information, information indicating an operation state of a plurality of devices constituting the remote monitoring system, and
the failure determination unit determines a failure in the remote monitoring system based on the state information acquired by the state information acquisition unit and the failure determination information.

3. The failure detection device according to claim 2, wherein
when information on the failure associated with the state information is not included in the failure determination information, the failure determination unit estimates a failure in the remote monitoring system based on information on the failure associated with a condition having a higher degree of similarity to the state information, among the conditions included in the failure determination information.

4. The failure detection device according to claim 2, comprising a failure determination information editing unit to edit the failure determination information, wherein
the failure determination information editing unit includes:
an acquisition unit to acquire information for editing the failure determination information; and
an update unit to update the failure determination information based on the information acquired by the acquisition unit.

5. (canceled)

6. The failure detection device according to claim 1, comprising a notification determination information editing unit to edit the notification determination information, wherein
the notification determination information editing unit includes:
an acquisition unit to acquire information for editing the notification determination information; and
an update unit to update the notification determination information based on the information acquired by the acquisition unit.

7. The failure detection device according to claim 1, wherein
when two or more failures in the remote monitoring system are determined by the failure determination unit, the failure information output unit generates a failure information list in which the two or more failures determined are ranked and arranged, and outputs the failure information list generated.

8. A monitoring control system comprising:
the failure detection device according to claim 1; and
the remote monitoring system.

9. A failure detection method executed by a computer, the method comprising:
a state information acquisition step of acquiring, from a remote monitoring system that monitors a facility provided in a remote location, state information indicating a state of the remote monitoring system;
a notification information acquisition step of acquiring, from a terminal device, notification information including information indicating a failure detail of the facility;
a failure determination step of selecting failure candidates for the remote monitoring system based on notification determination information and the notification information received by the notification information acquisition step, the notification determination information including information in which information indicating a failure detail of the facility is associated with information on a failure in the remote monitoring system, determining a failure in the remote monitoring system from the failure candidates based on the state information acquired by the state information acquisition step, and generating failure information indicating a detail of the failure determined; and
a failure information output step of outputting the failure information generated by the failure determination step.
